(19) United States
(12) Patent Application Publication
(10) Pub. No.: US 2010/0193417 A1
(43) Pub. Date: Aug. 5, 2010

(54) Exchangeable Filter

(75) Inventors: Pamela Gohl, Asperg (DE); Rainer Loos, Freiberg (DE); Dieter Schreckenberger, Marbach (DE); Michael Thienel, Kasendorf (DE); Ludwig Bammersperger, Reisbach (DE)

Correspondence Address: Mann+Hummel GMBH;Department VR-P, Hindenburgstr. 45, Ludwigsburg, 71638, DE

(73) Assignee: MANN+HUMMEL GMBH, Ludwigsburg (DE)

(21) Appl. No.: 12/677,328

(22) PCT Filed: Aug. 20, 2008
(86) PCT No.: PCT/EP08/60885

§ 371 Date: Apr. 16, 2010

(30) Foreign Application Priority Data
Sep. 11, 2007 (DE) 20 2007 012691.3

(51) Int. Cl. B01D 35/34; B01D 35/147

(52) U.S. Cl. 210/130; 210/443; 210/232

(57) ABSTRACT

The invention concerns of exchangeable filter (10) with a cup (11) and a cover (12). Within the cup (11) a filter element (13) for purifying liquid, in particular lubricant oil, is arranged. The cover comprises an outer contour (16, 17, 18), to which the upper area of the cup (11) is connected by a shaped crimp.

### TECHNICAL FIELD

The invention concerns a exchangeable filter according to the preamble of claim 1.

### PRIOR ART

Exchangeable filters are known that comprise a housing with a filter element arranged therein. The filter element separates seal-tightly an inlet from am outlet. The housing is comprised of a deep-drawn sheet metal cup, a cover, and a seal holder that is connected to the cover. The seal holder is arranged such on the cover that the cover by crimping of the seal holder is secured on the cup rim. In this connection, the seal holder is liquid-tightly crimped to the cup. For producing a liquid-tight crimp between the seal holder in the cup a separate seal is required. The cover itself is clamped between the seal holder and the cup so that the cover cannot move relative to the cup or the seal holder. Such exchangeable filters are disclosed, for example, in DE 102 04 505.

The object of the invention is to provide a exchangeable filter that can be produced in a simple and inexpensive way. This object is solved by the features of claim 1.

### SUMMARY OF THE INVENTION

The exchangeable filter according to the invention serves in particular for purifying lubricant oil of an internal combustion engine. Of course, also other liquids, for example, fuels, emulsions or water can be purified with the exchangeable filter according to the invention. The exchangeable filter comprises a housing with an inlet and an outlet wherein the inlet is separated by a filter element from the outlet. The filter element comprises a filter medium that is folded in a zigzag shape and may be of a closed ring shape. Such filter media are comprised, for example, of synthetic fiber nonwoven fabrics, cellulose or mixtures thereof. The housing comprises a cup and a cover wherein the cover has an external circumferentially extending contour to which an upper edge zone of a cup is crimped. In this connection, the cup is comprised of thin sheet metal that is mechanically formable. The external circumferentially extending contour of the cover is in the shape of a circumferential ring. The upper edge zone of the cup encloses the outer contour of the cover on at least two surfaces. One of these surfaces is the circumferential surface and the other surface is the end face of the ring. With this configuration a shaped crimp is provided that connects the cover directly with the cup. Accordingly, a simple assembly and at that the same time a reduction of parts is achieved.

In an advantageous embodiment, the upper edge zone encloses further surfaces of the cover, in particular the inner surface of the ring so that the cover is surrounded on three adjoining sides. In order to provide axial securing of the cover in the cup it may be advantageous when the cover is supported with its lower end face partially by the edge zone of the cup. Accordingly, the cover is surrounded at four surfaces by the cup and a relative movement between the cover and the cup is prevented.

Alternatively, or in addition to a four-sided connection between cup and cover, special projections or stays can be provided that provide positive-locking action between the components. Accordingly, by means of the cup a mounting or demounting torque can be transmitted onto the cover without this producing a relative movement between cover and cup.

According to a special embodiment of the invention on the cover a seal holder is arranged. The seal holder forms together with the contour of the cover a seal receptacle. In this connection, the contour of the cover provides the outer boundary for the seal and the seal holder forms the inner boundary for the seal. The seal holder that is in particular comprised of sheet metal can be glued, welded, screwed or riveted to the cover. Advantageously, the seal holder is spot-welded to the cover. Since no special requirements are placed onto the connection between the seal holder and the cover, a liquid-tight connection must not be produced so that this inexpensive and simply producible connecting method can be employed for connecting the seal holder to the cover.

In an alternative embodiment the cover is designed such that a seal holder is embodied in the form of an annular groove. For this purpose, the cover has an annular recess that is arranged within the external circumferentially extending contour of the cover. By means of this configuration additional components as well as additional mounting steps for forming the seal receptacle are obsolete.

According to a further embodiment of the exchangeable filter, between the filter element and the inlet a non-return valve is arranged. By means of this non-return valve it is prevented that in the mounted state of the exchangeable filter liquids can exit from the interior of the cup. The non-return valve comprises for this purpose an elastic lip that contacts seal-tightly the cover so that the interior of the cup is separated from the inlet openings within the cover.

In an advantageous embodiment of the invention, the non-return valve forms a seal between the filter element and the cover so that an additional sealing action between the filter element and the cover is no longer needed. In a special embodiment the non-return valve is inserted between the central tube of a sleeve or an additional part and the cover and forms in this way a radial seal. For this purpose, it is advantageous when the cover has an integrally formed annular collar on which a collar of the central tube may be supported. Alternatively, the end plate of the filter element may be provided with a collar that is supported on the annular collar of the cover. The non-return valve is then arranged between the collar of the end plate or of the central tube or the additional part and the cover and centers in this way the filter element in the housing so that additional centering means are not needed. The axial support of the filter element is realized by means of the element itself that is supported on a cup contour or a support contour on the bypass valve. In this connection, it is advantageous when the non-return valve is comprised of an elastomer material that is vulcanized onto the central tube of the filter element. In this way, a non-detachable liquid-tight connection between the non-return valve and the filter element is formed.

In a special embodiment of the exchangeable filter the filter element has end plates that are arranged at the end faces of the folded filter medium. These end plates are comprised preferably of thermoplastic synthetic material wherein the central tube or the support tube for the filter medium is formed directly on the end plate. In this way, one component takes on several functions so that mounting is simplified. There is the possibility of producing the end plates of metal. They may comprise a collar. Also, the central tube may be made of metal and is positioned floatingly between the two end plates. Moreover, the aforementioned additional parts may be produced of metal or synthetic material.

### BRIEF DESCRIPTION OF THE DRAWINGS

Further details of the invention will be explained in the following with the aid of the figures. It is shown in:

FIG. 1 a exchangeable filter in a perspective view, partially in section;

FIG. 2 a section of the cover according to FIG. 1; and

FIG. 3 a section of an alternatively designed exchangeable filter;

FIG. 4 an alternative embodiment of the exchangeable filter in a section view showing one half; and

FIG. 5 a detail view of a cover in a further variant.

### EMBODIMENTS(S) OF THE INVENTION

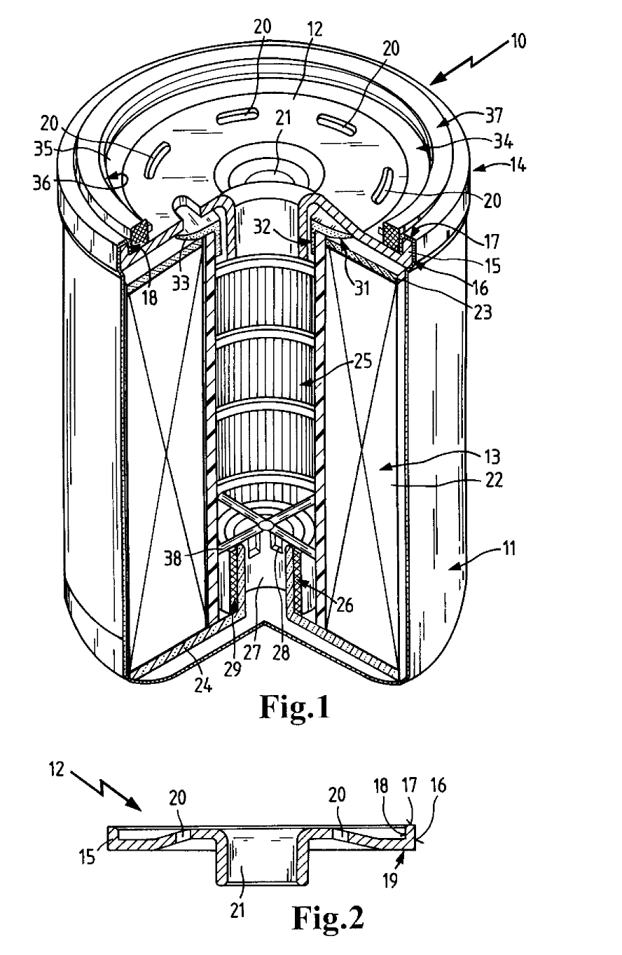

In FIG. 1, a exchangeable filter 10 is illustrated in perspective view, partially in section. The exchangeable filter 10 comprises a cup 11, a cover 12, and a filter element 13. The cup 11 is crimped with its upper edge area 14 to the cover 12. Upon crimping exclusively the upper edge area 14 of the cup 11 is deformed. The cover 12 is not appreciably deformed by the crimping action. In order to provide a positive-locking connection between the cover 12 and the cup 11, the cover 12 has a contour that is embodied as a circumferentially extending ring 15. The ring 15 is surrounded at its outer wall surface 16, its upper end face 17, and its inner annular surface 18 by the upper edge area of 14 of the cup 11. In addition to these enclosed surfaces, a portion of the cup 11 is resting against a lower end face 19 of the cover 12. The contact of the cover 12 on the lower end face 19 prevents the cover from dropping into the cup. The cover 12 has several inlet openings 20 distributed about the circumference that are of an oval shape. Moreover, the cover 12 has a centrally arranged outlet 21. The filter element 13 comprises a zigzag folded filter medium 22 that is connected with its upper end face to an end plate 23. At its lower end face the filter medium 22 has a further end plate 24. The lower end plate 24 is formed monolithically together with a support tube 25. The support tube 25 is permeable for the liquid to be purified and does not generate a considerable pressure loss. In the lower area of the support tube 25 a bypass valve 26 is arranged. The bypass valve 26 is formed by a cylindrical area 27 in the support tube 25 wherein in the cylindrical area 27 through openings 28 are provided. The through openings 28 or closed off by an elastic hose member 29. When the pressure at the raw side of the filter element 13 is too great, the hose member 29 is lifted off the through openings 28 and the liquid to be purified can pass without filtration to the internally arranged clean side of the filter element 13. In the area of the upper end plate 23 the support pipe 25 has an annular stop 30 on which the inwardly bent outlet 21 is supported. Above the stop 30 a non-return membrane 31 is connected by vulcanization. The non-return membrane 31 forms an inner sealing surface 32 and a sealing lip 33. By means of the sealing surface 32 a seal-tight connection between the cover 12 and the filter element 13 is produced. The sealing lip 33 contacts annularly the cover 12 so that in the no-flow state of the exchangeable filter no liquid can exit from the interior. This is advantageous in particular when exchanging the exchangeable filter 10 because no liquid is spilled. The cover 12 has a seal holder 34 that is secured by spot welding on the cover 12. The seal holder 34 is formed by a thin sheet metal with a fastening surface 35 and a support surface 36. On the fastening surface 35 the spot welds are produced. The support surface 36 forms together with the inner annular surface 18 a receptacle for a seal 37.

In FIG. 2, the cover 12 according to FIG. 1 is shown in section. Same components are identified with same reference numerals. The cover 12 is embodied as a master formed sheet metal part wherein the outlet 21 is deep-drawn. The inlet openings 20 are produced by stamping in a simple way.

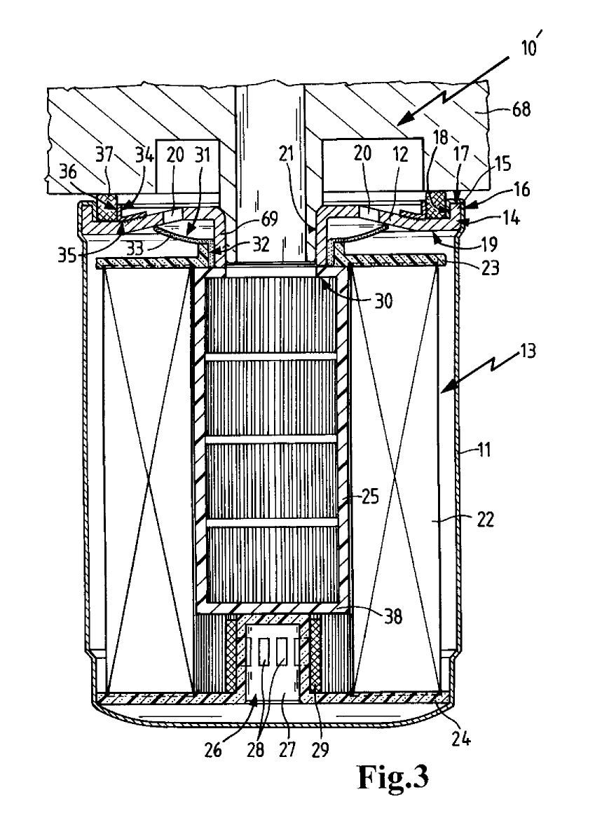

In FIG. 3, the exchangeable filter 10 according to FIG. 1 is illustrated in an alternative embodiment. Same components are identified with same reference numerals. In contrast to the embodiment illustrated in FIG. 1, the lower end plate 24 is embodied separate from the support tube 25. The bypass valve 26 is formed directly on the lower end plate 24. The support tube 25 is resting with its ribs 38 on the highest area of the bypass valve 26. The ribs 38 are embodied in analogy to the support tube 25 illustrated in FIG. 1 as crossing ribs 38. In the upper area of the filter element 13 the upper end plate 23 is embodied such that the seal surface 32 of the non-return membrane 31 is supported radially in circumferential direction. Accordingly, the sealing surface 32 between the outlet 21 and a partial area of the upper end plate 23 are seal-tightly pressed together. The support tube 25 contacts the bottom side of the lower end plate 23 and the end face of the cover 12 so that the axial position in the cup 11 is defined.

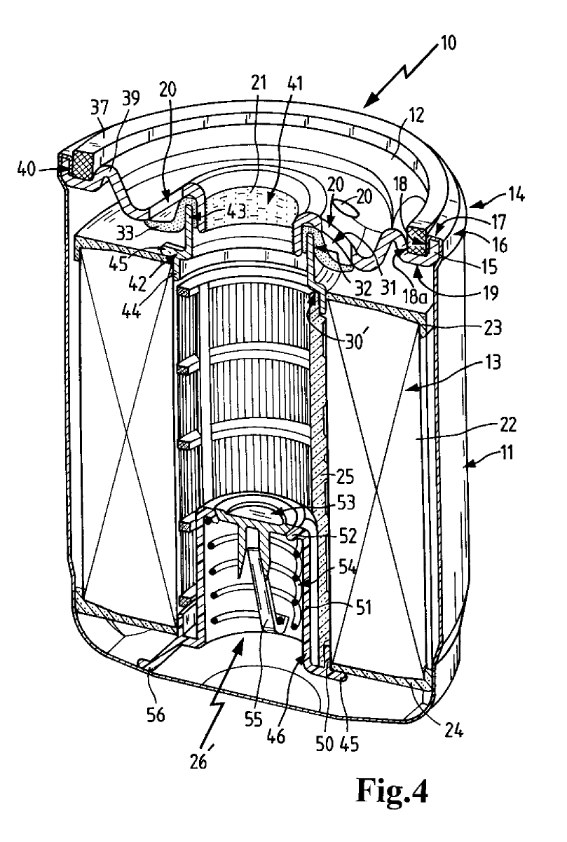

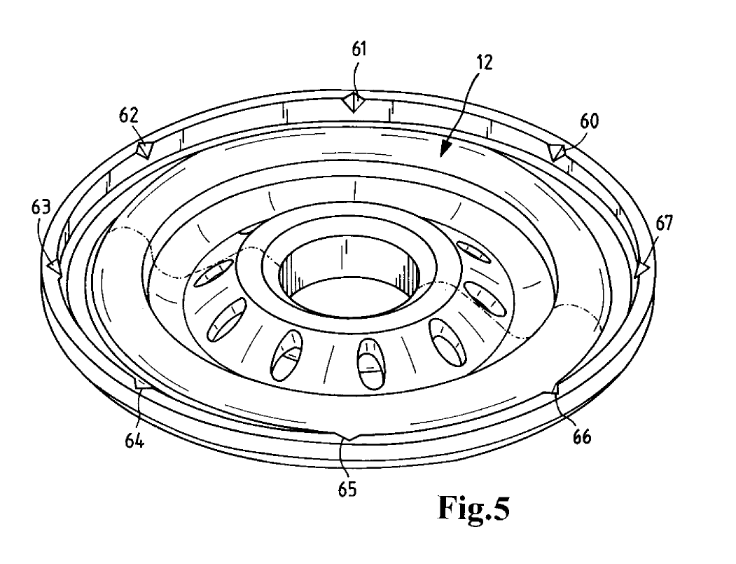

FIG. 4 shows a exchangeable filter 10 according to FIG. 1 in a further alternative embodiment. Same components are identified with same reference numerals. In contrast to the preceding figures the cover 12 is designed such that between the inner annular surface 18 and a bead 39 a seal receptacle 40 is formed. The seal 37 is inserted into this seal receptacle 40 that is formed monolithically by geometries of the cover 12. The bead 39 is formed by a forming process of the cover 12 in the form of a corrugation. The outlet 21 is embodied as an annular collar that is projecting into the interior of the cup 11. In this way, in the interior of the annular collar an inner thread 41 for attachment of the exchangeable filter 10 on a connecting member is provided. The inner thread 41, of course, can also be provided on the cover 12 of the preceding figures.

Moreover, the exchangeable filter 10 shown in FIG. 4 differs from the preceding figures in that the end plates 23, 24 are of a circular ring shape wherein a holder 42 for the non-return membrane 31 is inserted seal-tightly in the upper end plate 23. For this purpose, the holder 42 has a collar 43 onto which the non-return membrane 31 is placed. Moreover, the holder 42 has an insertion rim 44 that seal-tightly rests against the end plate 23. For avoiding that the holder 42 slides into the interior of the filter element 13, support elements 45 are provided that are distributed about the circumference of the holder 42. The exchangeable filter 10 according to FIG. 4 has moreover an alternatively designed bypass valve 26′. The bypass valve 26′ has a valve housing 46 that is seal-tightly inserted by means of insertion collar 50 into the lower end plate 24. Moreover, the valve housing comprises a cylinder area 51 that projects into the interior of the filter element 13. On the inner end of the cylinder area 51 a valve seat 52 is formed that, on the one hand, forms the matching surface relative to a valve plate 53 and, on the other hand, a support surface for a spring 54. The valve plate 53 is fixed with three valve legs 55 (as a result of the section illustration only one leg is shown completely) on the spring 54 so that the valve plate 53 when the pressure is too great at the raw side of the filter element 13 is lifted off the valve seat 52. In order for the bypass valve 26′ not to slide into the interior of the filter element 13, support elements 45 are distributed about the circumference. Moreover, for axial positioning of the bypass valve 26′ or the filter element 13 support legs 56 are provided that are supported at the bottom of the cup.

FIG. 5 shows in a perspective view the cover 12 without additional components. For avoiding free rotation of the cup 11 that engages with its crimped portion the cover, the cover 12 has arranged thereat securing noses 60, 61, 62, 63, 64, 65, 66, 67 that are uniformly distributed about the circumference. They are embossments that have the effect that after crimping of the cup 11 the cup in the area of its collar is positive-lockingly enclosed by the securing noses. In this way, a high torque can be transmitted from the cup onto the cover.

As an alternative to the positive-locking embodiment shown in FIG. 5, the cover 12 can also be provided with knurling in the crimped area. This knurling ensures that after crimping of the cup 11 a continuous reliable fixation of the cup 11 on the cover 12 is realized. Free rotation of the cup 11 on the cover 12 is prevented in this way.

1-14. (canceled)

15. An exchangeable filter for lubricant oil of an internal combustion, comprising:
a filter element; and
a housing enclosing said filter element, said housing including
a cup having an open end and a close bottom; and
a cover including at least one inlet and at least one outlet, said cover including a circumferentially extending ring circumscribing its outer portion, said circumferentially extending ring including an outer wall surface, an upper end face and an inner annular surface, said cover non-detachably connected to and covering over said open end of said cup;
wherein the inlet is separated by the filter element from the outlet;
wherein the non-detachable connection of said cover to said cup is formed by a shaped crimp in which an upper edge area of the cup proximate to said open end is pressed against and secureably deformed onto outer wall surface, upper end face and inner annular surface of said circumferentially extending ring of said cover; and
a seal is arranged resting on the cover at an at upper edge area of said cup, said seal positioned proximate to said inner annular surface.

16. The exchangeable filter according to claim 1, wherein
the seal is configured to compressibly for a a seal between a receiving plate of a mounting member mounting said filter onto the internal combustion engine and said cover.

17. The exchangeable filter according to claim 1, wherein
said cover includes an annular recess that forms a seal receptacle bounded by said circumferential outer ring of said cover, said seal receptacle configured to receive said seal positioned proximate to said inner annular surface.

18. The exchangeable filter according to claim 17, wherein
a seal holder is arranged on said cover forming and radially spaced inwards from said circumferentially extending ring forming said seal receptacle.

19. The exchangeable filter according to claim 18, wherein said seal holder is secured to said cover by any of: spot welding, annular welding, gluing or clinched thereto.

20. The exchangeable filter according to claim 2, wherein
a support structure is formed into said cover in the form of a circumferentially extending annular bead at a radially inner surface of said seal, forming a boundary and support for said seal.

21. The exchangeable filter according to claim 16, wherein said seal forms simultaneously said crimp of said cup and a sealing action between said receiving plate and said cover.

22. The exchangeable filter according to claim 2, wherein
said filter element comprises a bypass valve that includes an elastic hose member responsive to fluid pressure.

23. The exchangeable filter according to claim 2, wherein
a non-return valve is arranged within said housing enclosure between said filter element and said at least one inlet.

24. The exchangeable filter according to claim 23, wherein said filter element is seal-tightly connected to said cover by said non-return valve.

25. The exchangeable filter according to claim 23, wherein
said non-return valve is arranged on a collar of said cover, said non-return valve further arranged on a support tube of said filter element by an annular holder.

26. The exchangeable filter according to claim 1, wherein
said filter element comprises a zigzag-folded filter medium of a closed ring shape; and
wherein end plates are arranged on axially spaced end faces of said filter medium.

27. The exchangeable filter according to claim 26, wherein
at least one of said end plates is comprised of a thermoplastic synthetic material.

28. The exchangeable filter according to claim 26, wherein
a support tube of a thermoplastic synthetic material is directly formed integrally on one of said end plates.
